(19) United States
(12) Patent Application Publication
(10) Pub. No.: US 2024/0051316 A1
(43) Pub. Date: Feb. 15, 2024

(54) PRINTHEAD ALIGNMENT

(71) Applicant: Hewlett-Packard Development Company, L.P., Spring, TX (US)

(72) Inventor: David Peinado Gutierrez, Sant Cugat del Valles (ES)

(21) Appl. No.: 17/766,316

(22) PCT Filed: Dec. 2, 2019
(86) PCT No.: PCT/US19/63970

§ 371 Date: Apr. 4, 2022

(51) Int. Cl. B41J 25/304

(52) U.S. Cl. CPC B41J 25/304

(57) ABSTRACT

Examples described herein relate to printhead alignment in a printing system which may print onto media of different rigidity. An example method comprises determining a flatness profile for a first type of print medium on a platen of a printing apparatus. Using the flatness profile of the first type of print medium, first alignment compensation values are determined for a printhead to print onto the first type of print medium on the platen. The flatness profile for the first type of print medium is then also used to determine second alignment compensation values for the printhead to print onto a second type of print medium on the platen, the second type of print medium being more rigid that the first type of print medium.

### BACKGROUND

Page wide array (PWA) inkjet printheads, sometimes referred to as printbars, employ a plurality of printhead dies typically arranged in an offset and staggered fashion to span a print path. The printhead dies include an array of print nozzles, the nozzles being controllably sequenced to eject printing liquid drops in accordance with print data so as to collectively form a desired image in a single pass on a print medium as the print medium is continually advanced along the print path past the printhead.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a block schematic front view of a printing system according to an example;

FIG. 2 illustrates a side view of the printing system of FIG. 1;

FIG. 3 illustrates a plan underside view of a printhead according to an example;

FIG. 4 is a flowchart of an example method of printhead alignment according to an example;

FIG. 5 is a schematic of a processor and a computer readable storage medium with instructions stored thereon according to an example;

FIG. 6 illustrates sensor measurements across the width of a flexible print medium according to an example;

FIG. 7 illustrates sensor measurements across the width of a rigid print medium according to an example; and

FIG. 8 illustrates differences in alignment compensation values for flexible and rigid media at different locations across the platen according to an example.

### DETAILED DESCRIPTION

Page wide array (PWA) printheads employ a plurality of printhead dies, each printhead die including an array of print nozzles for ejecting printing liquid drops such as ink drops. The printhead dies may be arranged in a staggered and offset fashion across a full width of a print path, with the arrays of print nozzles of the plurality of printhead dies together forming a print zone. As print media is advanced through the print zone, the nozzles of the printhead dies are controllably sequenced in accordance with print data and movement of the print media, with appropriate delays to account for offsets between rows of nozzles and the staggered separation of the printhead dies, so that the arrays of nozzles of the printhead dies together form a desired image on the print media in a single pass as the print media is moved through the print zone.

Due to mechanical tolerances, misalignment can occur between printhead dies which results in misregistration or misalignment between the printed drops of printing liquid forming the image, thereby producing errors or artifacts in the printed image. To eliminate such errors, printers typically employ calibration systems to measure misalignment between printhead dies, with the measured misalignment used as a basis for some type of correction operation to compensate for die misalignment, such as adjusting the timing/sequencing of nozzle drop ejection between printhead dies, for example. Such calibration systems typically include printing a calibration page including a calibration pattern. The calibration pattern is scaled using an optical sensor to provide a digital image of the calibration pattern (e.g., optical density or reflectance), with misalignment between printhead dies being determined from pixel values of the digital image.

Misregistration or misalignment between printed drops of printing liquid forming the image may also occur due to surface features of the print media. Such features may include projections or depressions imparted to the print media by the underlying platen used to advance the print media through the print zone. The platen may comprise a number of belts, with the intersection of the belts forming a narrow valley and/or projecting rib in the print media along the direction of the print path. Similarly, vacuum ports in the platen arranged to retain the print media may also cause surface artifacts on the print media. These can result in light or dark line artifacts (e.g. streaks) in the printed image.

The level of impact of the underlying platen surface artefacts on the print media will depend on the rigidity of the print media. For example, more rigid print media such as cardboard will be less affected than more flexible print media such as paper. Therefore, the printhead needs to be calibrated (i.e. misalignment compensated for) for each type of print media used. For complex modern printing presses using PWA apparatus, this can take significant time. For example, the printhead in some modern printing presses may have thousands of nozzles per die with perhaps 10 dies, and printhead alignment compensation may take up to 15 minutes for each type of print media.

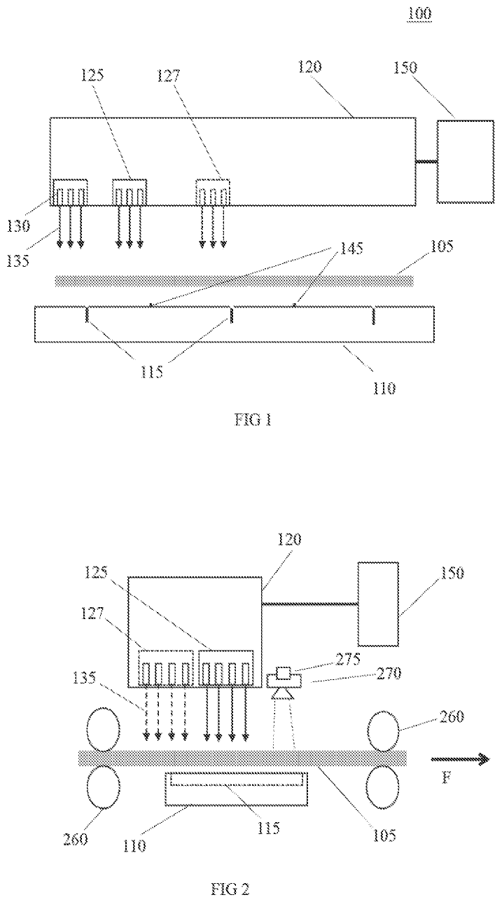

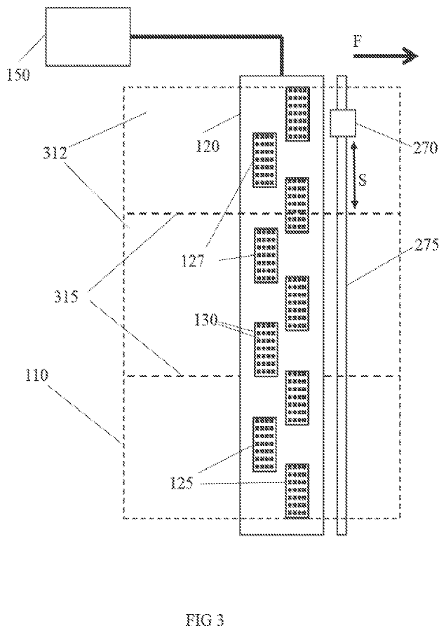

FIG. 1 is a block schematic front view of a printing system 100 according to an example. Side and plan underside views of the printing system 100 are also shown in FIG. 2 and FIG. 3 respectively. The printing system 100 comprises a printhead 120 and a platen 110 in between which a print medium 105 is advanced in order to print an image onto the print medium according to print data used by a controller 150 to control the platen and printhead. The printhead 120 comprises a plurality of dies 125, 127 each comprising a plurality of print nozzles 130 controllable to eject printing liquid 135 onto the print medium 105. The dies are staggered with leading dies 125 in front of lagging dies 127 in the direction F of advancing the print medium 105.

The platen 110 may have a non-flat surface onto which the print medium 105 is retained and which impacts on the flatness of the surface of the print medium. For example, the platen 110 may include a series of vacuum ports 115 which cause local depressions or valleys in the F direction in the surface of the print medium 105. The platen 110 may additionally or alternatively have local projections 145 or ribs in the F direction in the surface of the print medium. These non-flat features can be transferred to the print medium affecting its flatness profile. The flatness profile of the print medium will be affected by its rigidity so that non-flat zones 115, 145 of the platen 110 may cause similar non-flat zones in the surface of a flexible print medium such as paper. The effect may be much less pronounced for rigid print media such as cardboard.

In an example, the printhead 120 may have 42,420 nozzles 130, with 4224 nozzles per die 125, 127 and ten dies. The nozzles may be arranged in four rows on each die, for example one row per color (Yellow, Magenta, Cyan and Black), with 1056 columns of nozzles extending across the width of the printhead and print medium. Whilst misalignment of printing liquid drops ejected by a single nozzle may not be noticeable, misalignment of printing liquid drops ejected by a number of neighboring nozzles, for example caused by surface artefacts of the print medium, may be noticeable as lines of lighter or darker color as the printing liquid drops overlap printing liquid drops from other nozzles and leave gaps between printing liquid drops from neighboring nozzles. Such image artefacts may be compensated for by one or more of the following: ejecting printing liquid from different nozzles and/or additional nozzles; adjusting the timing of ejection of the printing liquid; applying complementary masks between groups of overlapping nozzles. For example, in the Y-axis (direction of medium advancement), alignment may be achieved by applying a delay for a misalignment determined in microns, and using this to calculate the delay taking account of printing parameters such as the speed of the printing liquid drop and media.

In an example determining these alignment compensation values for the printhead can be achieved by determining a flatness profile of the print medium. The flatness profile for the print medium may then be used to determine alignment compensation values for a different type of print medium having a different rigidity as will be described in more detail below. Using the flatness profile of the first print medium to determine alignment compensation values for both the first print medium and a second print medium of different rigidity saves considerable time in calibrating the printing system.

Examples of flexible media include paper, textiles, vinyl, canvas and flexible plastic derivatives. Examples of rigid media include cardboard, cartons, foamboards, thick or rigid paper derivatives, rigid plastic derivatives.

In an example, rollers 260 advance the print medium through the print zone between the printhead and platen in the print direction F, The platen 110 may comprise a number of belts 312 for assisting advancing the print medium. The surface of the platen at the intersection 315 where the belts meet may be discontinuous giving rise to projections or ridges 145. Vacuum ports may be positioned between the belts and could give rise to non-flat surface artefacts in these inter-belt zones.

In an example, one or more sensors 270 may be used to determine a flatness profile of the print medium 105 whilst on the platen. The sensors may be in fixed locations or a sensor 270 may be moveable along a carriage 275 in direction S across the width of the platen and print medium. The sensor may be an optical sensor for measuring color intensity or density, density of printing liquid, reflectance or other sensor parameters or optical properties of the print medium or platen. The print medium or platen may have a predetermined pattern used by the sensor to enhance accuracy of measurement of the sensor parameters. Different inferential patterns may be measured to perform coarse and then fine alignment.

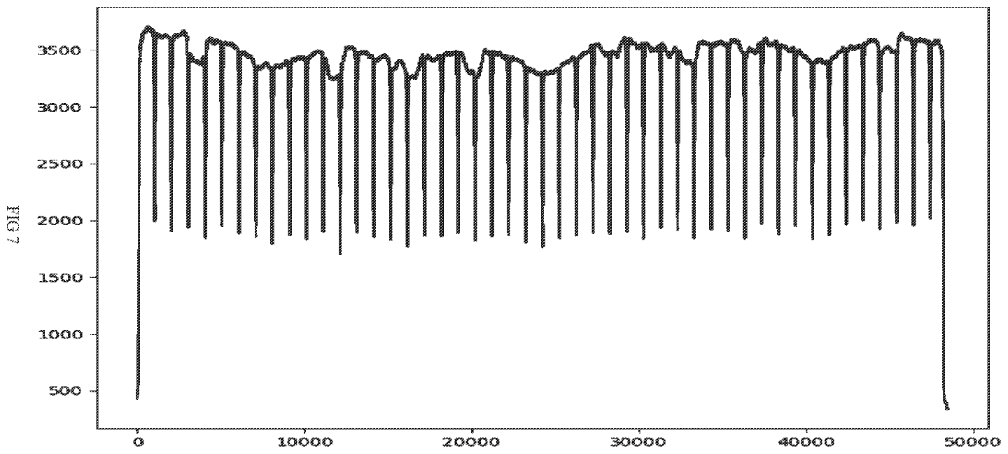

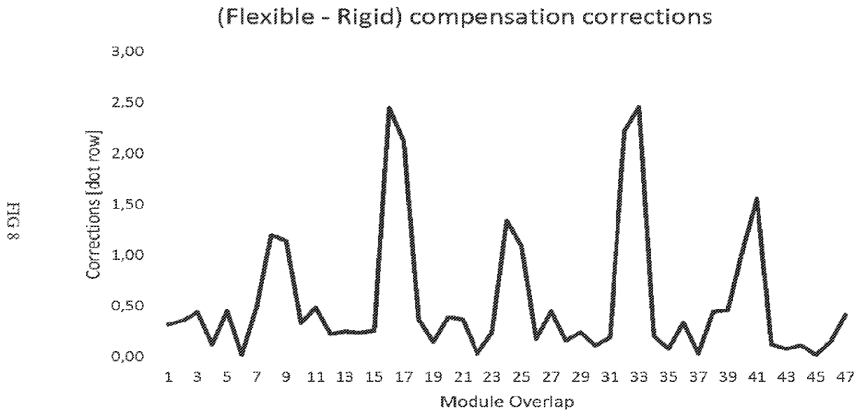

FIG. 6 illustrates color density measurements by a sensor across the width of a flexible print medium. The higher values correspond to black lines of a calibration pattern and the lower values correspond to white lines of the calibration pattern. These values are affected by the color of the pattern but also by the flatness of the print medium. It can be seen that there is considerable variation in the sensor parameter measurements across the page or platen. FIG. 7 illustrates measurements of the same sensor parameter and calibration pattern for a more rigid print medium. It can be seen that the values for the black and white lines of the pattern are much more consistent indicating that the surface of the more rigid print medium is flatter. As noted above, the flatness of the surface of the print medium is affected by the flatness of the platen and the rigidity of the print medium.

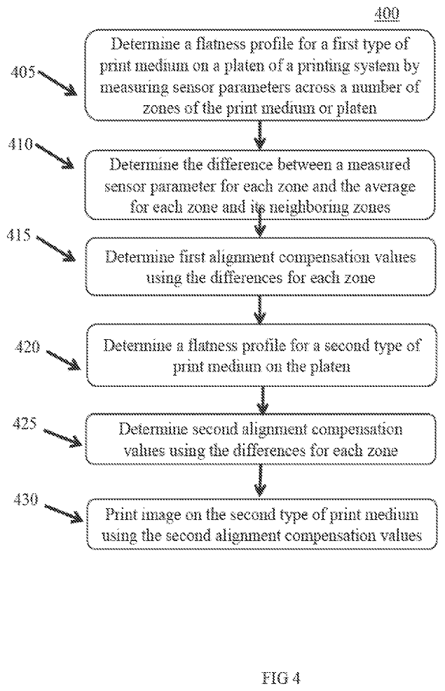

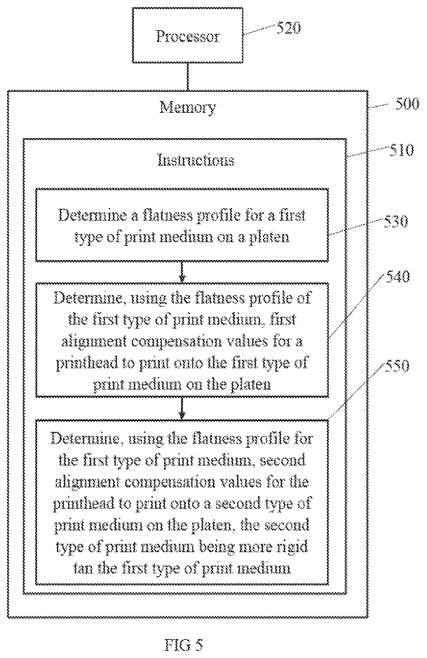

A method for determining printhead alignment compensation for different types of print media is illustrated in FIG. 4. The method 400 may be implemented on the printing system 100 of FIG. 1-3 by the controller 150.

At 405, the method determines a flatness profile for a first type of print medium on a platen of a printing system. In an example this is implemented by using a sensor to measure sensor parameters across a number of zones of the print medium or the platen. This may be enhanced using a pattern printed on the print medium or platen. The width of the platen or print medium may be divided equally into equal sized zones, and a reading from the sensor taken for each zone. The reading may be an average or integration of sensor output as it moves across the zone. Table 1 below show an example of eleven zones of a flexible print medium in which zones 2, 4, 6, 8 and 10 can be termed non-flat zones as they have significantly higher sensor measurements than the other zones. A non-flat zone may have a sensor measurement higher than a threshold larger than the average of that zone and the neighboring zones on either side.

TABLE 1

| | Sensor Count | Average of | Impact of non-flat |
|---|---|---|---|
| Zone | Average | neighbors | zones |
| 1 | 372.44 | | |
| 2 | 947.84 | 370.115 | 577.725 |
| 3 | 367.79 | | |
| 4 | 1263.6 | 370.965 | 892.636 |
| 5 | 374.14 | | |
| 6 | 601.31 | 383.59 | 217.72 |
| 7 | 393.04 | | |
| 8 | 1263.5 | 411.33 | 852.17 |
| 9 | 429.62 | | |
| 10 | 665.56 | 401.29 | 264.27 |
| 11 | 372.96 | | |

At 410, the method determines the difference between the measured sensor parameter for a zone and the average of the measured sensor zone and its neighboring zones. For the non-flat zones, the average of the sensor readings of that zone and its neighboring zone on either side is shown in the middle column of Table 1. The difference between this average and the sensor reading or measured sensor parameter of the non-flat zone is shown in the right column. This shows the impact or level of the non-flatness of the non-flat zones. For the other “flatter” zones (1, 3, 5, 7 9, 11), the difference between the sensor reading for that zone and the average of that zone and its two neighboring zones can also be determined and is much lower.

At 415, the method determines the first alignment compensation values for the printhead to print onto the flexible medium. In an example this is achieved using the measured sensor parameters for each zone which are then used to determine an alignment compensation value for that zone for the flexible print medium. The alignment compensation values may be determined experimentally and applied depending on the measured sensor parameters—average sensor counts in this example, but other parameters could alternatively be used. The alignment compensation values could be delays, masking of groups of nozzles for example in overlapping regions, lateral transformation of nozzles used and other compensation values that could be used. Whilst the above example describes 11 zones for simplicity, any number of zones may be employed. In an example 48 zones are used each with its own measured sensor parameter.

At 420, the method determines a flatness profile for a second (rigid) type of print medium on the platen. In an example this is achieved by using the flatness profile of the first type of print medium and replacing the sensor readings of the non-flat zones with the previously determined averages of these zones and their neighboring zones. Table 2 below shows how the sensor readings are modified for the rigid medium. For example, zone 1 is a flat zone with a measured sensor parameter below a threshold (e.g. within 20%) of the average measured sensor parameter of the neighboring zones or the average of all the zones. Zone 2 is a non-flat zone having a measured sensor parameter much larger than its neighbors (zone 1 and 3, and also the average of zones 1, 2 and 3). The measured sensor parameter for this non-flat zone is therefore replaced with the average of the three neighboring zones (zones 1, 2 and 3). Similarly, non-flat zones 4, 6, 8 and 10 have their measured sensor parameters replaced with average values for the local group of neighboring zones.

TABLE 2

| | | Simulated sensor count for rigid |
|---|---|---|
| Zone | Sensor Count Average | medium |
| 1 | 372.44 | 372.44 |
| 2 | 947.84 | 370.115 |
| 3 | 367.79 | 367.79 |
| 4 | 1263.6 | 370.965 |
| 5 | 374.14 | 374.14 |
| 6 | 601.31 | 383.59 |
| 7 | 393.04 | 393.04 |
| 8 | 1263.5 | 411.33 |
| 9 | 429.62 | 429.62 |
| 10 | 665.56 | 401.29 |
| 11 | 372.96 | 372.96 |

At 425, the method determines the second alignment compensation values for the printhead to print onto the rigid medium. In an example this is achieved using the above described differences for each zone but using the replaced simulated sensor readings for the non-flat zones, and which are then used to determine an alignment compensation value for that zone for the rigid print medium.

At 430, the method prints an image onto the rigid medium using the second alignment compensation values. FIG. 8 illustrates the difference in alignment compensation values for the flexible and rigid media at different locations across the platen. The larger differences correspond to inter belt regions and other platen surface irregularities that more significantly affect the flexible medium that the rigid medium.

The method allows for the possibility to use flexible media to perform printhead alignment calibration for rigid media, which are more expensive to use. It also provides a time saving as one calibration process is sufficient for printing in a plurality of media, with the sensor readings from the flexible medium being used to determined printhead calibration values for the rigid medium as well. There is also a customer benefit in reducing the level of interaction with the printing system to calibrate for rigid media.

Whilst the method and arrangements for printhead alignment for different types of media has been described using PWA printing systems, these methods and arrangements are also applicable to other types of printing systems such as inkjet printers with printheads on moveable cartridges. In other examples the method and arrangements may also be applicable to 3D printing applications such as Binder jet 3D printing and metal 3D printing in which a suitable printing agent such as a liquid binder is ejected from the printhead. In other examples non-liquid printing agents may be ejected by the printhead.

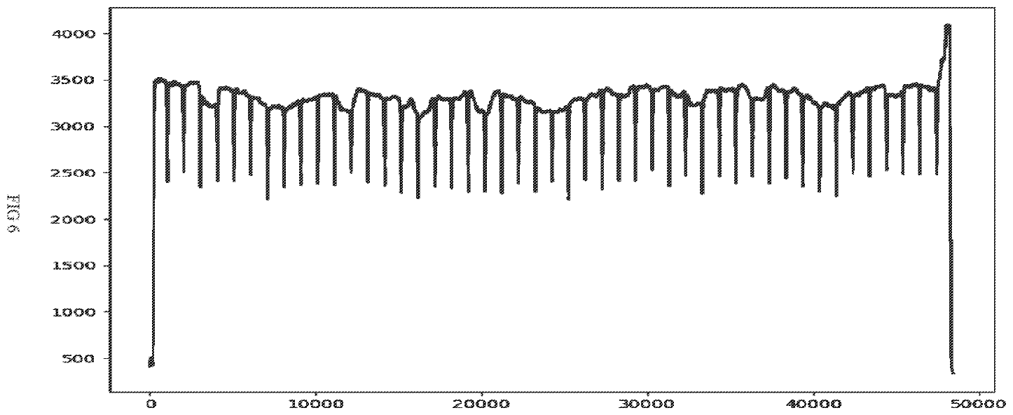

FIG. 5 shows a computer-readable storage medium 500, which may be arranged to implement certain examples described herein. The computer-readable storage medium 500 comprises a set of computer-readable instructions 510 stored thereon. The computer-readable instructions 510 may be executed by a processor 520 connectably coupled to the computer-readable storage medium 500. The processor 520 may be a processor of a printing system similar to printing system 100. In some examples, the processor 520 is a processor of a controller such as controller 150.

Instruction 530 instructs the processor 520 to determine a flatness profile for a first type of print medium on a platen. In an example, this may be implemented by measuring sensor parameters, such as a reflectance reading from an optical sensor. The flatness profile may be arranged into zones where the sensor parameter for each zone may be the average sensor reading.

Instruction 540 instructs the processor 520 to determine, using the flatness profile of the first type of print medium, first alignment compensation values for a printhead to print onto the first type of print medium on the platen. The first alignment compensation values may be provided for each zone using the average sensor reading for that zone. Alignment compensation values for different sensors readings may be determined experimentally and applied using a lookup table or a function derived from the experimental work.

Instruction 530 instructs the processor 520 to determine, using the flatness profile of the first type of print medium, second alignment compensation values for a printhead to print onto a second type of print medium on the platen, the second type of print medium being more rigid than the first type of print medium. In an example, this may be implemented by determining non-flat zones in the profile and replacing their sensor readings with those based on an average of the local zones, for example the non-flat zone and their neighboring zone on either side.

Processor 520 can include a microprocessor, microcontroller, processor module or subsystem, programmable integrated circuit, programmable gate array, or another control or computing device. The computer-readable storage medium 800 can be implemented as one or multiple computer-readable storage media. The computer-readable storage medium 500 includes different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. The computer-readable instructions 510 can be stored on one computer-readable storage medium, or alternatively, can be stored on multiple computer-readable storage media. The computer-readable storage medium 500 or media can be located either in the printing system 500 or located at a remote site from which computer-readable instructions can be downloaded over a network for execution by the processor 520.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with any features described, and may also be used in combination with any feature of any other examples, or any combination of any other examples.

What is claimed is:

1. A method comprising:
determining a flatness profile for a first type of print medium on a platen of a printing apparatus;
determining, using the flatness profile of the first type of print medium, first alignment compensation values for a printhead to print onto the first type of print medium on the platen;
determining, using the flatness profile for the first type of print medium, second alignment compensation values for the printhead to print onto a second type of print medium on the platen, the second type of print medium being more rigid that the first type of print medium.

2. The method of claim 1, wherein determining the flatness profile comprises measuring sensor parameters across the platen or first type of print medium.

3. The method of claim 2, wherein the sensor parameters are one of: color density; density of printing liquid; reflectance.

4. The method of claim 1, comprising determining non-flat zones amongst a plurality of zones of the flatness profile by measuring sensor parameters for each zone.

5. The method of claim 4, comprising determining the alignment compensation values for the non-flat zone using the sensor determined parameter for said non-flat zone and one or more neighboring zones.

6. The method of claim 5, comprising determining the first alignment compensation value for each zone using the respective measured sensor parameter for said zones.

7. The method of claim 6, comprising determining the second alignment compensation value for the non-flat zone by using the average of the sensor parameters for the non-flat zone and one or more neighboring zones.

8. The method of claim 4, wherein a non-flat zone has a sensor parameter above a threshold compared with the average sensor parameters of the non-flat zone and one or more neighboring zones.

9. The method of claim 1, wherein the flatness profile is determined by measuring optical properties of a predetermined pattern on the platen or first type of media.

10. The method of claim 1, wherein the first print medium is a flexible medium comprising one of: paper; textiles; vinyl; canvas; plastic derivatives; and the second print medium is a rigid medium comprising one of: cardboard; cartons; foamboards; paper derivatives; plastic derivatives.

11. A printing system comprising:
a platen to receive a print medium;
a printhead to print onto the print medium;
a processor to:
determine a flatness profile for a first type of print medium on the platen;
determine, using the flatness profile of the first type of print medium, first alignment compensation values for a printhead to print onto the first type of print medium on the platen;
determine, using the flatness profile for the first type of print medium, second alignment compensation values for the printhead to print onto a second type of print medium on the platen, the second type of print medium being more rigid that the first type of print medium.

12. The printing system of claim 11, comprising a sensor to measure sensor parameters across the platen or first type of print medium

13. The printing system of claim 11, wherein the printhead is stationary when printing and comprises a plurality of dies each comprising a plurality of nozzles to ejects drops of a printing agent onto the print medium.

14. The printing system of claim 11, comprising a vacuum apparatus to urge the print medium to the platen during printing.

15. A non-transitory computer-readable storage medium comprising a set of computer-readable instructions that, when executed by a processor, cause the processor to:
determine a flatness profile for a first type of print medium on the platen;
determine, using the flatness profile of the first type of print medium, first alignment compensation values for a printhead to print onto the first type of print medium on the platen;
determine, using the flatness profile for the first type of print medium, second alignment compensation values for the printhead to print onto a second type of print medium on the platen, the second type of print medium being more rigid that the first type of print medium.
